(19) United States
(12) Patent Application Publication
(10) Pub. No.: US 2010/0045406 A1
(43) Pub. Date: Feb. 25, 2010

(54) RF FILTER MODULE

(76) Inventor: Krister Andreasson, Stockholm (SE)

Correspondence Address: Myers Andras Sherman LLP, 19900 MacArthur Blvd., Suite 1150, Irvine, CA, 92612, US

(21) Appl. No.: 12/441,367

(22) PCT Filed: Aug. 31, 2007
(86) PCT No.: PCT/SE2007/000759

§ 371 Date: Mar. 13, 2009

(30) Foreign Application Priority Data
Sep. 14, 2006 (SE) 0601890-7

(51) Int. Cl. H01P 1/20

(52) U.S. Cl. 333/202

(57) ABSTRACT

The present invention relates to a RF filter module adapted to be connected between an electric circuit and a least one antenna element. The filter module comprises a cavity within a filter housing having a housing wall, and at least one resonator being provided inside said cavity. The housing wall of the filter housing is provided with at least one aperture allowing RF signals to be coupled between an externally arranged non penetrating coupling part and the resonator (s) provided inside said cavity. The invention also relates to a RF filter arrangement and a system for communicating RF signals.

### TECHNICAL FIELD

The present invention relates to a RF filter module as defined in the preamble of claim 1. The invention also relates to a filter arrangement as defined in the preamble of claim 7, and a system as defined in the preamble of claim 14.

### BACKGROUND TO THE INVENTION

In antenna systems for telecommunication purposes, filters are used to extract the desired frequency content in a broad band telecommunication signal, and simultaneously to block the undesired frequency contents to avoid interferences. Different communication systems operate close to each other in the spectrum, and there is thus a need to separate closely spaced signals using filters with high selectivity. High selectivity filters require resonators with a high Q factor, usually implemented as cavity filters with resonator bodies. The cavities may be empty waveguide cavities or loaded with a conductive rod (TEM or coaxial resonator) or a dielectric material (TE or TM dielectric resonator). This type of filter has the disadvantage of being bulky and also requires a good signal connection into and out of the filter.

In antenna systems, the antenna elements, filters and amplifiers are constructed in different ways and are therefore divided into separate modules. At present, the modules are manufactured and measured separately before assembly.

A filter having a high Q-value is described in an article with the title “A novel approach for integrating high-Q band-pass filters into microwave integrated circuit assemblies”, by Gerald E. Johnson and Michael D. Medley, pages 1309-1311, IEEE MTT-S Digest, 1993. In the article, a simplified approach is described for creating a filter-to-PCB interface, with a filter housing securely attached through soldering or epoxy, to create the necessary cavity for the resonators. Coupling rods are arranged within the housing which rods are coupled to transmission lines printed on the PCB.

The described cavity filter is constructed in such a way that it is not easy to maintain and to replace a malfunctioning filter when it is mounted in an antenna system, especially when mounted close to the antenna in a telecommunication mast.

Thus, there is a need to provide a new type of filter for telecommunication purposes.

### SUMMARY OF THE INVENTION

An object of the present invention is to provide a filter that is easy to maintain and to replace, if malfunctioning, compared to prior art filters.

A further object is to enable easy replacement of components connected to the filter, such as an antenna coupling part or an amplifier which is coupled to the filter.

These objects are achieved by providing a filter module as defined in the characterizing portion of claim 1, and a filter arrangement as defined in the characterizing portion of claim 7.

Another object is to provide a system having a filter that is easy to maintain and enabling easy replacement thereof or of various components coupled to the filter.

This object is achieved by providing a system as defined in the characterizing portion of claim 1.

An advantage of the present invention is that the size of the filter can be reduced compared to conventional filters.

Another advantage of the present invention is that the filter module may be constructed in a sealed housing, preventing moisture and undesired substances to enter the filter cavity and change the filter characteristics.

### BRIEF DESCRIPTION OF THE DRAWINGS

FIG. 1 shows an antenna system including a prior art filter;

FIG. 2 shows an antenna system including a first embodiment of a filter arrangement according to the present invention;

FIG. 3 shows an antenna system including a second embodiment of a filter arrangement according to the present invention;

FIGS. 4 and 5 show schematic views of an antenna system according to an alternative embodiment of the present invention; and

FIG. 6 shows an antenna system including a further embodiment of the present invention, with two filters.

### DETAILED DESCRIPTION OF PREFERRED EMBODIMENTS

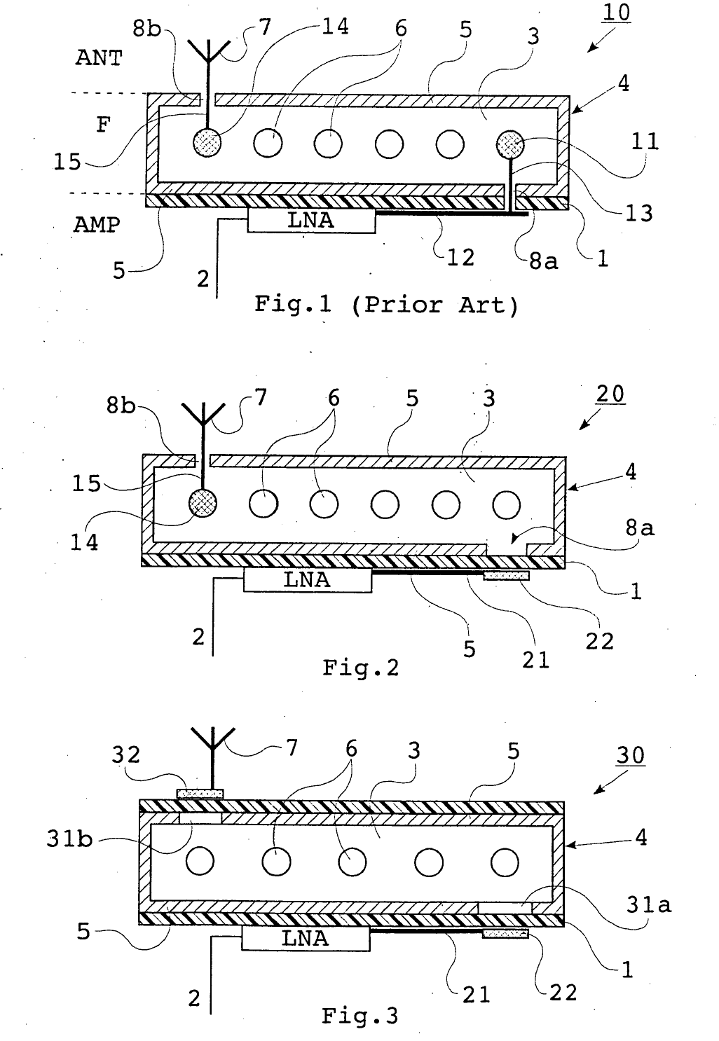

FIG. 1 shows an antenna system 10 including a commonly used RF filter in the prior art. The antenna system 10 comprises three parts: an amplifier AMP, a filter F and an antenna ANT. The amplifier is in this example a Low Noise Amplifier LNA arranged on a printed circuit board (PCB) 1. Signals are fed between the LNA and a control unit (not shown) through wires 2. The LNA is also connected to a first coupling rod 11 inside a cavity 3 through printed circuits 12 on the PCB 1 and a connecting wire 13. A filter housing 4 having housing walls 5 that delimits the cavity 3 contains a number of resonators, commonly denoted 6.

In FIG. 1, one of the resonators inside the cavity is the first coupling rod 11, and another resonator is a second coupling rod 14 being in communication with the antenna ANT. The antenna ANT comprises at least one antenna element 7, and is coupled to the second coupling rod 14 through a connecting wire 15. Apertures 8a, 8b in the form of openings are provided in the housing walls 5 to allow the connecting wire 13 and the connecting wire 15 to penetrate into the cavity and make contact with the first and second coupling rods 11,14, respectively.

If a filter needs to be replaced, the whole system has to be dismounted from the antenna site and the filter connecting wires 13,15 to the coupling rods of the filter have to be removed before a new filter may be installed. However, if a more bulky design is used and external connectors are provided on the filter housing 4, cables attached to the connectors may be dismounted before the filter is removed and replaced. The disadvantage with this type of bulky design is that it requires more space, is more costly to manufacture and a good seal for the wall entrance must be provided.

The present invention generally relates to a new design for a cavity filter, where the input signal and/or output signal of the filter is coupled through an aperture between an external input coupling part and an output coupling part. The term “aperture coupled filter” is defined herein as a filter in which no physical object or material penetrates the aperture, which means that a sealed housing, made of a metallic material or coated internally with a layer of conducting material, can be used as long as there is at least one area present in the housing through which an RF signal may be coupled between the externally arranged coupling parts and the resonators within the filter housing.

One of the essential features is that the input/output coupling part constitutes a part of the filter characteristics, which means that the filter housing will have an incomplete filter characteristic if the input and/or output coupling part is not present. However, the externally arranged coupling part is normally not a resonator in the sense that it contributes to the filter order, i.e. the order of the filter polynomial, but only acts as an impedance transformer from the external port impedance (50 ohm) to the internal impedance of the filter (which can be several kohm for a narrowband filter). Often, the input and output coupling parts are not resonant, such as purely inductive or purely capacitive coupling, or at least the resonant frequency is well outside the passband of the filter. The loaded Q of the coupling part is also very low compared to the internal resonators, so the resonance of the coupling part can be hard to detect.

The input/output coupling part may be implemented as a microstrip on a printed circuit board, where the input/output can have a low Q-value, but the rest of the filter has a high Q-value. “Microstrip” is in this context intended to include any type of planar transmission line such as microstrip, stripline and suspended stripline etc. Also, suspended plate transmission lines like the ones used in some antenna feed line structures (sheet metal feed network) are possible. Conductive rods could also be used as input/output rod, for example when integrating two filter housings by coupling them through an aperture.

The invention will now be described in connection with FIGS. 2-6. Similar features in different figures will be denoted with the same reference signs in order to make the inventive features more clear to a person skilled in the art.

FIG. 2 shows an antenna system 20 including a filter according to a first embodiment of the present invention. A filter housing 4, with housing walls 5, made of an electrically conducting material, e.g. a metallic material, or coated with such a material, delimits a cavity 3 wherein a number of resonators 6 are arranged. A printed circuit board (PCB) 1 is arranged close to a housing wall 5, having a first aperture 8a.

A Low Noise Amplifier LNA is arranged on the PCB 1 and is connected to a control unit (not shown) through wires 2, and a printed circuit 21 is provided on the PCB to connect the LNA to a microstrip that will function as a first coupling part 22 for the filter. The first coupling part 22 will, in this embodiment, together with the resonators 6 inside the cavity 3, provide the complete characteristics of the filter.

An antenna 7, having one or more antenna elements, is connected to a second coupling part 14, which in this embodiment is one of the resonators 6 inside the cavity 3, and a connecting wire 15 is provided between the antenna 7 and the second coupling part 14 through a second aperture 8b.

The size of the amplifier and the filter is thereby reduced since there is no need for providing connectors to ensure a good RF connection therebetween. The coupling of the RF signals between the antenna 7 and the filter may naturally also be provided in a similar manner as between the first coupling part 22 and the resonators 6, shown in FIG. 3.

The first aperture 8a could be covered with a material that will allow RF signals to pass through and mechanically seal the opening in an environmentally favorable way. Glass, plastics, and other non-conductive materials are good examples of such materials. However, although it is strictly not necessary to provide a sealed aperture to benefit from the advantages offered by the present invention, additional advantages may be obtained with a sealed aperture.

FIG. 3 shows an antenna system 30 including a filter according to a second embodiment of the present invention. A filter housing 4, with housing walls 5, delimits a cavity 3 wherein a number of resonators 6 are arranged. A printed circuit board (PCB) 1 is arranged close to a housing wall 5, having a first aperture 31a sealed with a material that will allow RF signals to be coupled to the resonators 6 inside the cavity 3.

A Low Noise Amplifier LNA is arranged on the PCB 1 and is connected to a control unit (not shown) through wires 2, and a printed circuit 21 is provided on the PCB to connect the LNA to a microstrip that will function as a first coupling part 22 for the filter.

An antenna 7, having one or more antenna elements, is connected to a second coupling part 32 which, in this embodiment, is located outside the cavity 3, and the RF signals are coupled to the resonators 6 inside the cavity through a second aperture 31b sealed with a material allowing RF signals to be coupled to the resonators 6 inside the cavity 3. The second coupling part 32 may be separate from the antenna 7, or it may be an integrated part of the antenna.

The first coupling part 22 and the second coupling part 32 will, in this embodiment, together with the resonators 6 inside the cavity 3, provide the complete characteristics of the filter.

The size of the complete antenna system, including the antenna, the amplifier and the filter is thereby further reduced, since there is no need for providing connectors to ensure a good RF connection between the parts of the system.

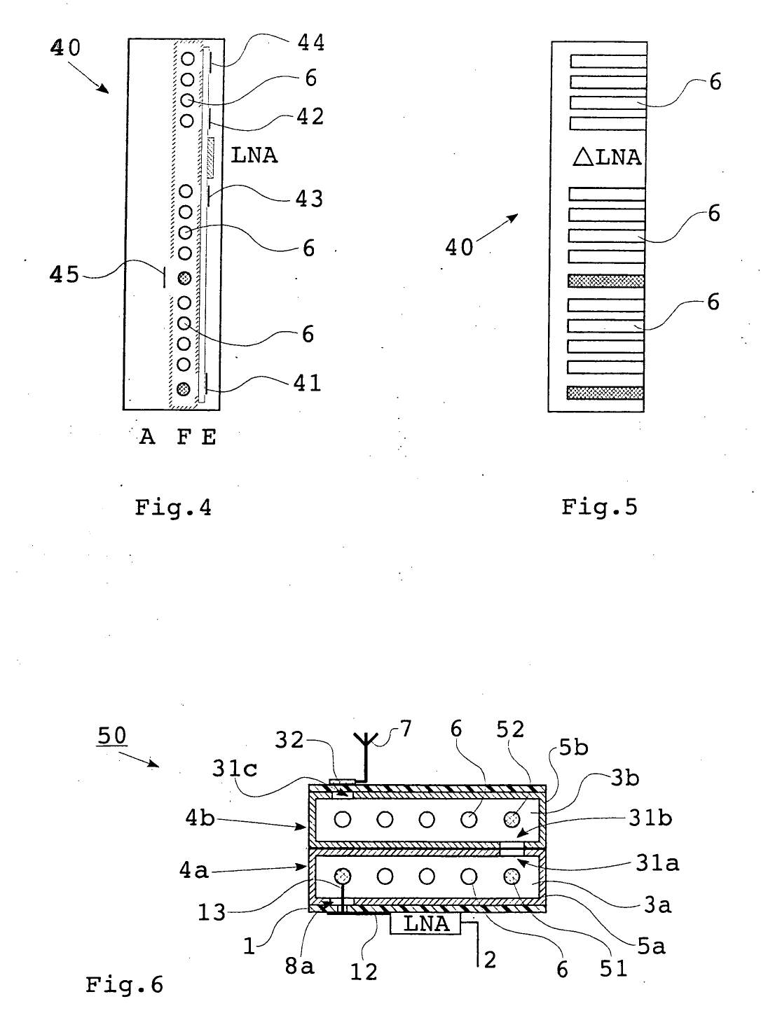

FIGS. 4 and 5 show schematic views of an antenna system 40. The antenna system in FIG. 4 comprises an antenna, a filter and an electric part of the antenna system. The filter has two input coupling parts 41 and 42, two output coupling parts 43 and 44, and one combined input/output coupling part 45, which in this case forms part of an antenna. The transmission signal (Tₓ) is fed into the coupling part 41 from a Modulator (Mod) and Power Amplifier (PA) to the antenna coupling part 45 through a first part of the filter. The received signal (Rₓ) from the antenna coupling part 45 is fed to the coupling part 43 through a second part of the filter. The received signal is transmitted from the coupling part 43 implemented on a LNA (Low Noise Amplifier) board through the LNA to the coupling part 42. The amplified received signal is then fed to the coupling part 44 through a third part of the filter to a demodulator. FIG. 5 shows the antenna system 40 from the side, illustrating how the resonators 6 in the filter are arranged and how compact the antenna system will be when implemented in this manner.

FIG. 6 shows an antenna system 50 including two filters according to a third embodiment of the present invention. Filter housings 4a and 4b, with housing walls 5a and 5b, delimits cavities 3a and 3b wherein a number of resonators 6 are arranged. A printed circuit board (PCB) 1, provided with a LNA, is arranged close to a housing wall 5a of a first filter, having a first aperture 8a. Signals are fed between the LNA and a control unit (not shown) through wires 2. The LNA is also connected to a first coupling rod 11, which is one of the resonators 6 inside a cavity 3, through printed circuits 12 on the PCB 1 and a connecting wire 13.

The filter housing 4a is provided with a second aperture 31a, similar to the aperture disclosed in connection with FIG. 3, and aligned with a first aperture 31b of the second filter housing 4b. A first coupling part 51 in the first filter, being one of the resonators inside the cavity 3a of the first filter, couples a RF signal to a second coupling part 52, being one of the resonators inside the cavity 3b of the second filter.

An antenna 7, having one or more antenna elements, is connected to a third coupling part 32 located outside the cavity 3b of the second filter, and the RF signals are coupled to the resonators 6 inside the cavity 3b through a third aperture 31c sealed with a material that will allow RF signals to be coupled to the resonators 6 inside the cavity 3b. The third coupling part 32 may be separate from the antenna 7, or it may be an integrated part of the antenna element.

The first coupling part 51, the second coupling part 52 and the third coupling part 32 will, in this embodiment, together with the resonators 6 inside the cavities 3a and 3b, provide the complete characteristics of the integrated filter.

In FIG. 6, the two filters 4a, 4b are coupled in series. However, in an alternative embodiment (not shown), they may be coupled in parallel, e.g. in a branching arrangement with a common feed connector.

It should be noted that although the disclosed embodiments show filters having several resonators inside a cavity, the invention is applicable to filters having only one resonator (or only a few resonators) inside a cavity.

The feature “resonator” is typically used for a complete resonating structure. A “resonator cavity” or “resonator rod” is used when drawing attention to a specific part of the resonator. “Resonator component”/“part”/“body” etc. may give the skilled person an idea that the filter is constructed from separable components but usually they are closely integrated into a common housing. Sometimes, but not always, the resonator rods can be separated from the housing. A type of filter that consists of separable resonators is a ceramic TEM mode filter where small quarter wave coaxial resonator blocks are soldered together. The feature “resonator”, in the specification and claims, is intended to apply to all types of resonators mentioned above.

Furthermore, the actual realization of the resonators is intended to be general since the invention is directed toward means to connect a RF signal with a cavity through an aperture. For instance, empty cavities separated by irises, cavities loaded with a conductive part (quarter wave rod) or cavities loaded with dielectric parts (ceramic rods or pucks) may be used. Different resonant modes or even multiple modes can be utilized for some of these cavity types.

Individual cavities, e.g. in a comb-line filter, are not easily identified as there are no irises between the resonators but the coupling is set by the distance to the adjacent resonators. In this case, the word “resonator” shall be interpreted as the regions where the energy of the resonant modes are concentrated, e.g. a resonator rod plus the space inside the filter cavity up to half the distance to the adjacent rods.

If desired, an external coupling rod may couple a RF-signal to/from more than one resonator in the same filter through separate apertures, or through a common aperture. Such multiple input or output couplings create finite frequency transmission zeroes (FTZ) just like cross couplings between internal resonators do. Typically, the first and second or first and third resonators are coupled to each other creating a single FTZ, or a pair of FTZ:s respectively.

The size of the aperture, through which the external coupling part couples RF signals, is typically the same size as one side of the input resonator cavity, preferably full length and full width, or a fraction thereof depending on the relative bandwidth of the filter. Smaller apertures may be applied for filters with a narrower bandwidth. The aperture is preferably larger than one fifth of the resonator length and also larger than half the cavity width.

An example of a material used to cover the aperture in the filter is some kind of PCB material where coupling structures or antenna patches can be printed directly on the aperture material. This is a convenient way to integrate a cavity filter with other passive or active circuitry. Any other insulating material with good electrical (such as low loss), mechanical and environmental properties may also be used. Plastic materials like cross linked polystyrene (Rexolite), PTFE (Teflon) and epoxy-glass (FR4) are used in similar applications. However, if a hermetic seal of the filter is required, a preferred material to use includes glass or ceramic aperture material.

In the above description, only one antenna element is exemplified, and the invention should not be limited only to cases where the filter couples directly to a single antenna element, but also coupling to the antenna as a whole.

1. A RF filter module adapted to be connected between an electric circuit and an antenna provided with at least one antenna element, said filter module comprising:
a cavity within a filter housing having a housing wall, and
at least one resonator being provided inside said cavity, wherein,
the housing wall of said filter housing is provided with at least one aperture allowing RF signals to be operatively coupled between an externally arranged non-penetrating coupling part and the resonator(s) provided inside said cavity.

2. The RF filter module according to claim 1, wherein said housing wall is made of or coated internally with an electrically conducting material.

3. The RF filter module according to claim 1, wherein said at least one aperture is an opening in said housing wall.

4. The RF filter module according to claim 1, wherein said at least one aperture comprises a section of the housing wall having a dielectric property that allows coupling of RF signals.

5. The RF filter module according to any of claim 1, wherein at least one aperture is provided for feeding RF signals into said filter module and/or at least one aperture is provided for outputting RF signals from said filter module.

6. The RF filter module according to any of claim 1, wherein a filter characteristic of a filter comprising said filter module is influenced by each externally arranged non-penetrating coupling part.

7. A RF filter arrangement adapted to be connected between an electric circuit and an antenna provided with at least one antenna element, said filter arrangement comprising:
at least one cavity within an associated filter housing having a housing wall, and
at least one resonator being provided inside said cavity, wherein
said RF filter arrangement further comprises at least one external coupling part arranged outside said cavity, and
said housing wall of said filter housing is provided with at least one aperture allowing RF signals to be coupled between at least one external non-penetrating coupling part and the resonator(s) provided inside said cavity, said externally arranged non-penetrating coupling part being a structural part of said electronic circuit or said antenna.

8. The RF filter arrangement according to claim 7, wherein said at least one aperture is an opening in said housing wall.

9. The RF filter arrangement according to claim 7, wherein said at least one aperture comprises a section of the housing wall having a dielectric property that allows coupling of RF signals.

10. The RF filter arrangement according to claim 7, wherein at least one aperture is provided for feeding RF signals to said resonator(s) inside said cavity and/or at least one aperture is provided for outputting RF signals from said resonator(s) inside said cavity.

11. The RF filter arrangement according to claim 7 wherein a filter characteristic of said filter arrangement is influenced by each externally arranged non-penetrating coupling part.

12. The RF filter arrangement according to claim 7, wherein said filter arrangement comprises at least two filters arranged close to each other.

13. The RF filter arrangement according to claim 12, wherein said at least two filters are operatively coupled in series.

14. A system comprising an electronic circuit, at least one RF filter and an antenna having at least one antenna element, said system being arranged to communicate RF signals between the electronic circuit and said antenna through said RF filter(s), said filter(s) comprising:
a cavity within a filter housing having a housing wall, and
at least one resonator being provided inside said cavity, wherein,
said RF filter(s) further comprise(s) at least one external coupling part arranged outside said cavity,
said housing wall of said filter housing is provided with at least one aperture allowing RF signals to be coupled between at least one external, non-penetrating coupling part and the resonator(s) provided inside said cavity, and
said externally arranged non-penetrating coupling part is a structural part of said electronic circuit or said antenna.

15. The system according to claim 14, wherein said at least one aperture is an opening in said housing wall.

16. The system according to claim 14, wherein said at least one aperture comprises a section of the housing wall having a dielectric property that allows coupling of RF signals.

17. The system according to claim 14, wherein at least one aperture is provided for feeding RF signals to said resonator(s) inside said cavity and/or at least one aperture is provided for outputting RF signals from said resonator(s) inside said cavity.

18. The system according to claim 14, wherein a filter characteristic of said filter arrangement is influenced by each externally arranged non-penetrating coupling part.
